(19) United States
(12) Patent Application Publication
(10) Pub. No.: US 2017/0018925 A1
(43) Pub. Date: Jan. 19, 2017

(54) Advanced Power Strip Having a High Level Interface

(71) Applicant: TrickleStar LTD, Causeway Bay (HK)

(72) Inventor: Bernard Christopher Emby, Kuala Lumpur (MY)

(21) Appl. No.: 15/209,119

(22) Filed: Jul. 13, 2016

Related U.S. Application Data
(60) Provisional application No. 62/192,863, filed on Jul. 15, 2015.

(51) Int. Cl. H02J 3/00; H01R 13/66; H01R 25/00

(52) U.S. Cl. CPC H02J 3/00; H01R 25/003; H01R 13/6683

(57) ABSTRACT

An advanced power strip includes a housing. The housing includes: at least one control outlet; at least one always-on outlet; at least one switched outlet; and at least one high-level interface operatively connecting a control device connected to the at least one control outlet, and a device connected to the at least one always-on outlet. The advanced power strip is configured to determine a status of the control device via the high level interface and, if the status of the control device is determined to be in an off state: (1) placing the device connected to the at least one always-on outlet into a low power sleep state by sending a command to the device via the high-level interface; and (2) switching the at least one switched outlet to an off state.

### CROSS REFERENCE TO RELATED APPLICATION

This application claims the benefit to U.S. Provisional Patent Application No. 62/192,863, filed on Jul. 15, 2015, the disclosure of which is incorporated by reference in its entirety.

### BACKGROUND OF THE INVENTION

Field of the Invention

The present invention relates generally to electrical power delivery devices, and, more particularly, to an energy saving electrical extension cord with electrical outlets (commonly referred to as a “power strip”) having a high level interface.

Description of Related Art

One type of electrical extension cord, commonly known as a power strip, generally comprises an elongated box-like housing having a row of plug-receiving receptacles formed therein, an on/off switch, and a single power cord which is connectable to a standard AC nominal 110 volt (foreign 220 volts) wall or other outlet. The power cord is typically plugged into the power outlet to energize the power strip. Thereafter, a plurality of devices may be plugged into the various plug receiving receptacles of the power strip. When the on/off switch of the power strip is turned to its “ON” position, current will flow to the plug-receiving receptacles and any devices which are plugged into the receptacles will become energized. Conversely, when the on/off switch is placed in its “OFF” position, devices which are plugged into the electrical power strip will become de-energized. Some of the currently available electrical power strips include resettable circuit breakers and generally include circuitry involving power surge suppression and noise filtration, to protect the personal computer from power surges, noise that comes from standard AC power, and power outages or blackouts. Some power controllers also include backup power supply in the form of a battery that can sustain the computer if a power outage or blackout occurs.

In addition, these conventional power strips do not reduce or eliminate vampire power unless the power strip is switched to the “OFF” position. Also known as standby power, leaking electricity, or phantom load, vampire power is wasted electrical energy consumed while certain appliances are switched off but still plugged in. These appliances range from televisions, home entertainment systems, personal computers and peripherals, to space heaters, room air-conditioners, and coffee pots. All of these appliances continue to draw power even when they are turned off. Averaging 10-15 watts per hour per device, vampire power is a constant drain on a person's wallet as well as the electrical grid.

Various government analyses estimate that the amount of standby power wasted accounts for as much as 12% of all residential power. The average United States household wastes over 1,300 kWh of electricity each year due to standby power. The cost of standby power wasted by plug-in products in the United States is approximately $4-8 billion annually.

Accordingly, advanced power strips have been developed to address the problem of vampire power. Currently, two general types of advanced power strips have been offered. The first type utilizes current sensing and a simple master/slave configuration to sense when a TV is switched on and to then switch peripherals on, and to sense when the TV is switched off and to switch the peripherals off. Such power strips save energy by manually switching power off (i.e., hard switching) to peripheral devices. Typically, such power strips have lower energy savings potential as only the peripheral devices are controlled and the solution is reliant upon the user to switch off the TV.

A second, more sophisticated type of power strip utilizes multiple control/sensing technologies to control TV peripherals as well as the TV. Such power strips utilize current or root-mean-square (RMS) sensing and a simple master/slave configuration to sense when a TV is switched on and to then switch peripherals on, and to sense when the TV is switched off and to then switch the peripherals off. These power strips also utilize an absence sensor with a countdown timer to detect user absence and then switch off the TV and peripherals. The combination of these technologies allows for greater energy savings as the product determines user absence by sensing for a lack of infrared (IR) activity or motion.

However, many current consumer electronic devices include hard disk drives or require a persistent internet connection. These include game consoles with hard disk drives (HDD), set top boxes with hard disk drives, smart televisions with persistent Internet connections, and streaming devices such as Google Chromecast™ and Apple TV®.

The power strips discussed hereinabove save power by manually switching power off to devices (often referred to as hard switching). Devices with a hard disk drive do not function well when hard switched and sometimes this can lead to hardware damage or the corruption of data. In addition, devices with a persistent Internet connection can also lockup or take an unacceptably long time to boot up again after a hard-switch off.

Devices are increasingly being developed that support energy saving modes/quiescent states which can be invoked through a high-level communicating interface, such as an Ethernet or WiFi network connection, USB interface, or HDMI interface, for example. This is referred to as soft switching (i.e., putting a device into an off/energy saving state without having to hard-switch power off to the device).

Accordingly, a need exists for a power strip that includes such a high level interface for placing a device connected thereto into a low power sleep state when the device connected to the control outlet is turned off, thereby preventing damage to hardware, corruption of data, and lengthy boot up periods.

### SUMMARY OF THE INVENTION

In accordance with one example of the present disclosure, there is provided a power management system for preventing abrupt switching of at least one device. The power management system comprises a mechanism configured to place the device into a low power state by sending a command to the device. More specifically, the power management system comprises: a power strip comprising: a housing having at least one control outlet, at least one first outlet, and at least one second outlet; at least one interface operatively connecting a control device connected to the at least one control outlet, and a first device connected to the at least one first outlet; at least one sensor interface; and an absence sensor operatively connected to the at least one sensor interface and configured to detect the presence of a user of the control device. The power management system is configured to determine a status of the control device via the at least one interface and, if the status of the control device is determined to be in an off state, the first device is set to a low power state and the at least one second outlet is switched to an off state. Alternatively, or in addition to, the first device may be set to a low power state and the at least one second outlet may be switched to an off state in the event an absence of a user is detected by the absence sensor.

The at least one control outlet may be a master outlet and the at least one second outlet may be a slave outlet. The at least one first outlet may be maintained at an on state. Alternatively, the power strip may further comprise a masterless configuration such that the at least one second outlet is capable of individual switching. The individual switching may be operated via an external device.

The at least one interface may be a high-level interface. The high level interface may be at least one of at least one wireless network, a high-definition multimedia interface, a universal serial bus interface, and any combination thereof. The absence sensor may be selected from a group of proximity sensors or a group of optical sensors. Specifically, the absence sensor may be at least one of an infrared sensor, a passive infra-red sensor, a motion sensor, a radio frequency sensor, and any combination thereof.

The system may be configured with a resettable timer function. The system may also be configured to determine power supply to the control device by sequentially sensing at least one activity of a user. In such an example, the system may terminate power supply when at least one activity is undetected within a predetermined period of time. More specifically, the system may: a) detect a first activity for a first predetermined period of time; b) detect a second activity for a subsequent predetermined period of time; c) if the first activity is undetected within the first predetermined period of time, the system may trigger an alert within a length of time; and d) if the second activity is undetected at the end of the subsequent predetermined period of time, the system may terminate power supply.

In accordance with another example of the present disclosure, provided is a power strip that comprises at least one control outlet; at least one first outlet operatively connected to the at least one control outlet; at least one second outlet operatively connected to the at least one first outlet; and at least one interface operatively connecting a control device connected to the at least one control outlet and a first device connected to the at least one first outlet. The power strip is configured to determine a status of the control device via the interface and, if a status of the control device is determined to be in an off state, the first device is set to a low power state by sending a command to the first device via the at least one interface, and the at least one second outlet is switched to an off state.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a top plan view of an advanced power strip in accordance with one example of the present disclosure;

FIG. 2 is a top plan view of an advanced power strip in accordance with another example of the present disclosure;

FIG. 3 is a top plan view of an advanced power strip in accordance with a further example of the present disclosure; and

FIG. 4 is a top plan view of an advanced power strip in accordance with yet another example of the present disclosure.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention is a power management system for preventing abrupt switching of at least one device. The power management system comprises a mechanism configured to place the device into a low power state by sending a command to the device. More specifically, the power management system includes a power strip, and an absence sensor configured to detect the presence of a user.

The power strip includes: a housing having at least one control outlet, at least one first outlet, at least one second outlet, at least one interface operatively connecting a control device connected to the at least one control outlet, a first device connected to the at least one first outlet, and at least one sensor interface. The power strip operates with the absence sensor to detect the presence of a user of the control device operatively connected to the sensor interface. The system is configured to determine a status of the control device via the interface, and if the status of the control device is determined to be in an off state, the first device is set to a low power state and the at least one second outlet is switched to an off state.

In addition, the power management system is configured to determine the status of the control device via the interface, and if the absence sensor detects absence of a user, a signal is provided by the sensor interface to set the control device and the first device to a low power state and to switch the at least one second outlet to an off state.

In one example, the power strip of the power management system includes, but is not limited to, a master and slave configuration. In such a master slave configuration, the at least one control outlet is the master configuration and the at least one second outlet is the slave configuration. The at least one first outlet is desirably maintained at an on state.

In another example, the power strip comprises a masterless configuration such that the at least one second outlet is capable of individual switching. The individual switching is operated via an external device such as a remote control, smartphones, tablets, and other suitable devices.

The interface is a high-level interface such as, but not limited to, at least one wireless network, a high-definition multimedia interface, a universal serial bus interface, or any combination thereof.

The absence sensor may be selected from a group of proximity sensors or optical sensors. More specifically, the absence sensor may be an infrared sensor, a passive infrared sensor, a motion sensor, a radio frequency sensor, or any combination thereof.

The system may be configured with a resettable timer function. In such instances, the system is configured to determine power supply to the control device by sequentially sensing at least one activity of a user, and terminate power supply in an event at least one activity is undetected within a predetermined period of time. More specifically, the power management system may be configured to detect a first activity for a first predetermined period of time, and detect a second activity for a subsequent predetermined period of time. If the first activity is undetected within the first predetermined period of time, the system triggers an alert within a length of time, and if the second activity is undetected at the end of the subsequent predetermined period, the system terminates power supply.

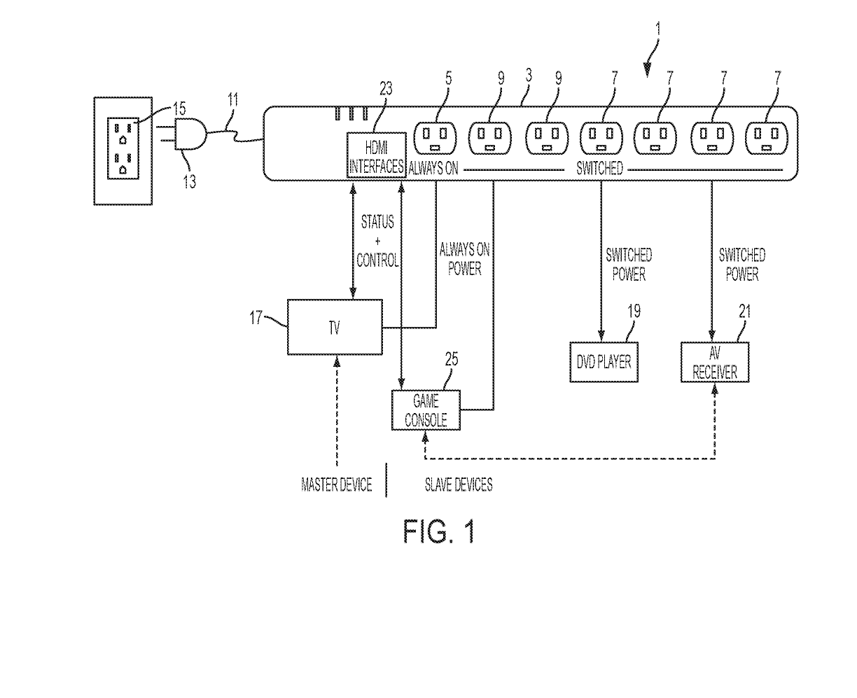

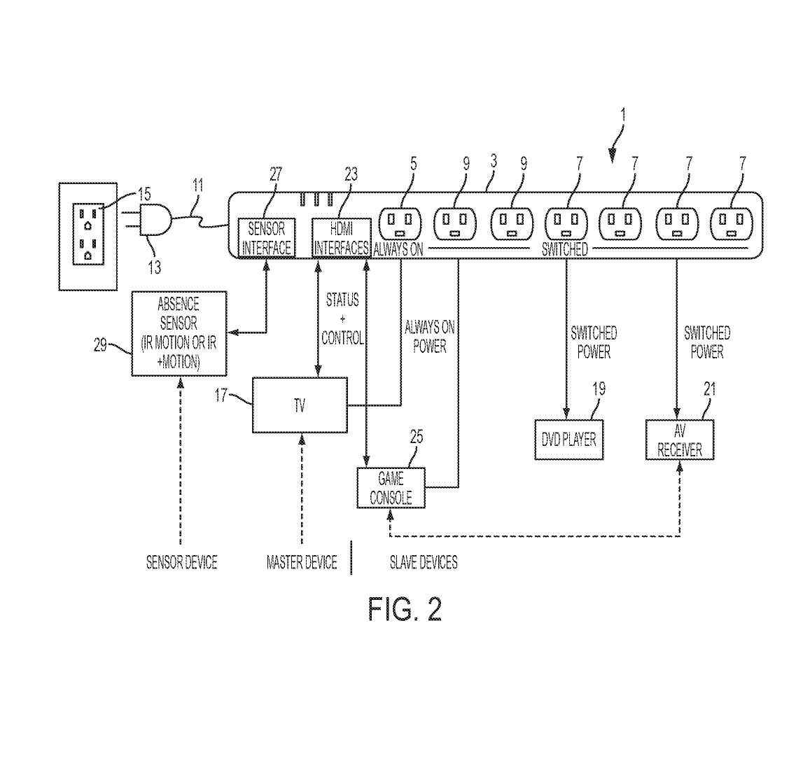

With reference to FIGS. 1 and 2, a power strip, denoted generally as reference numeral 1, comprises at least one control outlet 5, at least one first outlet 9 operatively connected to the at least one control outlet 5, at least one second outlet 7 operatively connected to the at least one first outlet 9, and at least one interface 23 operatively connecting a control device 17 connected to the at least one control outlet 5, and a first device 25 connected to the at least one first outlet 9. The power strip 1 is configured to determine a status of the control device 17 via the interface 23, and if the status of the control device 17 is determined to be in an off state the first device 25 is set to a low power state by sending a command to the first device 25 via the interface 23, and the at least one second outlet 7 is switched to an off state.

The power strip shown in FIGS. 1 and 2 includes a housing 3. Housing 3 is desirably manufactured from a plastic material that is UV stable. Housing 3 may also include a plurality of mounting holes (not shown) on a bottom portion thereof for mounting advanced power strip 1 to a surface, such as a floor or wall. Housing 3 may be substantially rectangular. Housing 3 further includes the at least one control outlet 5, the at least one first outlet 9 (i.e., an always-on outlet), the at least one second outlet 7 (i.e., switched outlets), and a mains power cord 11 ending in a male mains voltage plug 13 that is configured to be coupled to a female mains voltage receptacle 15. This embodiment of power strip 1 includes one control outlet 5, two always-on outlets 9, and four switched outlets 7.

The control outlet 5 measures current draw of a control device, such as a personal computer (not shown) or television 17, and causes switched outlets 7 to switch on or off depending on whether the control device 17 is on or off based on a switching threshold. This causes the devices connected to the switched outlets 7, such as DVD player 19 and AV receiver 21, to be manually switched off (i.e., hard switched) when the television 17 is switched off. The switching threshold sets the level at which control outlet 5 determines whether a control device 17 coupled thereto is on or off, and, thus switches switched outlets 7 on or off. The switching threshold may be adjusted by a threshold trimmer (not shown). The switching threshold may range from about 5 W to about 8 W.

The plurality of switched outlets 7 are switched on a single relay (not shown). The relay is desirably a mechanically latching relay that is rated for a minimum of 100,000 operations at full load. In addition, the relay should be configured to operate with minimum noise such that it is not audible from a distance of more than 2 meters. Always-on outlets 9 remain on at all times.

The power strip 1 of the power management system may include, but is not limited to a master and slave configuration. In such a configuration, the at least one control outlet 5 is the master configuration and the at least one second outlet 7 is the slave configuration. In an example of the power strip 1, the at least one first outlet may be maintained at an on state.

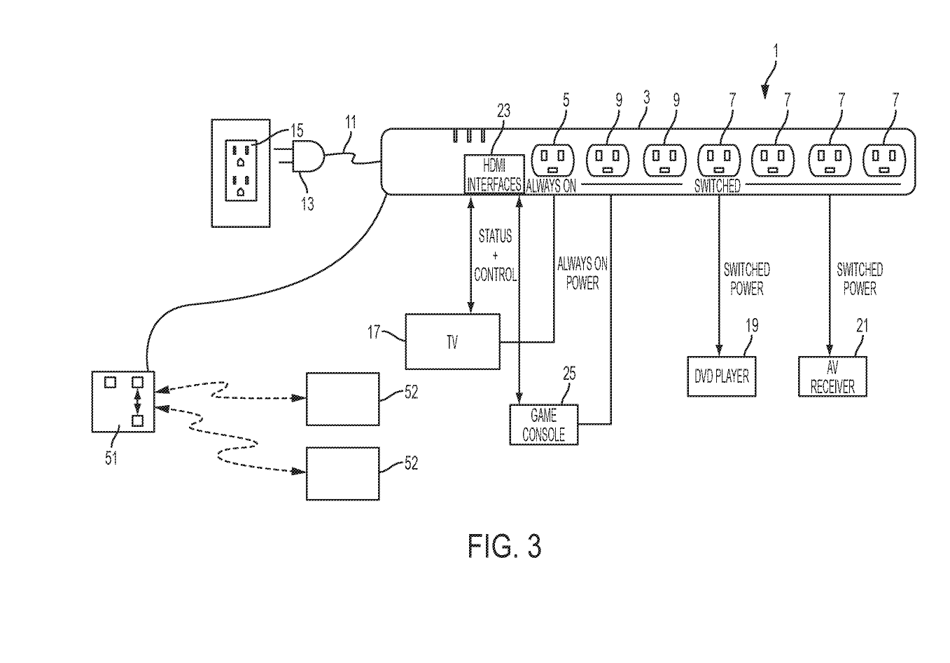

In another example, the power strip 1 comprises a masterless configuration such that the at least one second outlet 7 is capable of individual switching. In such a configuration, the individual switching is operated via an external device 52 such as a remote control, smartphones, tablets, and the like, connected to an external accessory 51 as shown in FIG. 3.

The advanced power strip 1 further includes a high-level interface 23 operatively connecting the control device, such as television 17, that is connected to the control outlet 5 and a device, such as video game console 25 connected to one of the always-on outlets 9. The high-level interface 23 may be one or more of an Ethernet network connection, a Wi-Fi network connection, a high-definition multimedia interface (HDMI), and a universal serial bus (USB) interface.

The advanced power strip 1 is configured to determine a status of the control device, such as television 17, via software commands provided on the high-level interface 23 and, if the status of the television 17 is determined to be in an off state it places the game console 25 connected to the always-on outlet 9 into a low power sleep state by sending a command to the game console 25 via the high level interface 23. This prevents the game console 25 from being hard switched off, thereby preventing damage to hardware, corruption of data, and lengthy boot up periods for a user. In addition, when the television 17 is turned back on, the high-level interface 23 sends commands to the game console 25 to return it to an on state.

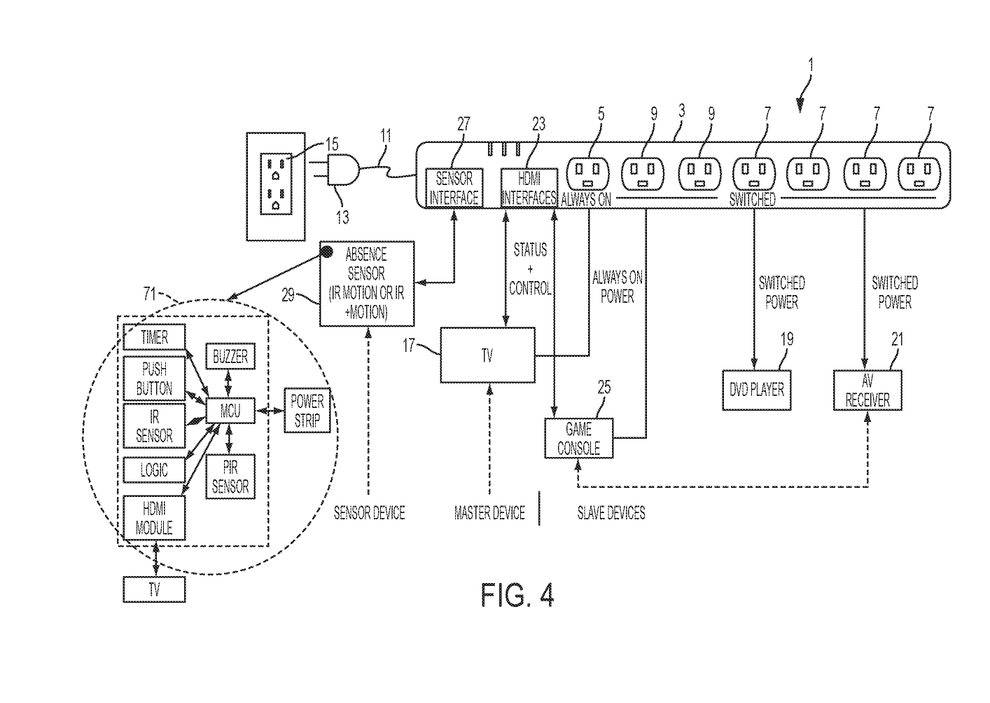

With reference to FIG. 2, advanced power strip 1 may further include a sensor interface 27. An absence sensor 29 is operatively connected to the sensor interface 27. The absence sensor 29 is configured to detect the presence or absence of a user of the television 17 (i.e., control device). The absence sensor 29 may be an infrared (IR) sensor, a motion sensor, or any combination thereof. As shown in FIG. 4, within the absence sensor 29, the power strip is configured with a resettable timer 71 function.

The absence sensor 29 may comprise a microcontroller unit (MCU), an infrared (IR) sensor, a passive infrared (PIR) sensor, a push button, logic module, an HDMI module, and a buzzer.

If the absence sensor 29 detects the absence of a user, a signal may be provided by the sensor interface 27 to switch the television 17 connected to the control outlet 5 and the game console 25 connected to the always-on outlet 9 to a low power sleep state, and to switch the at least one switched outlet 7 to an off state, thereby turning the DVD player 19 and the AV receiver 21 off.

The advanced power strip 1 of the present disclosure prevents the hard switching of certain devices (smart televisions, game console with HDDs, and streaming devices with persistent internet connections). Such hard switching can result in damage to hardware, corruption of data, and lengthy boot up periods for a user. By preventing such hard switching, the advanced power strip 1 described hereinabove results in a more positive user experience and prevents the de-installation of the product.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

The invention claimed is

1. A power management system for preventing abrupt switching of at least one device, the power management system comprising a mechanism configured to place the device into a low power state by sending a command to the device.

2. A power management system comprising:
a power strip comprising: a housing having at least one control outlet, at least one first outlet, and at least one second outlet; at least one interface operatively connecting a control device connected to the at least one control outlet and a first device connected to the at least one first outlet; and at least one sensor interface; and
an absence sensor operatively connected to the at least one sensor interface and configured to detect the presence of a user of the control device,
wherein the system is configured to determine a status of the control device via the at least one interface and, if the status of the control device is determined to be in an off state, the first device is set to a low power state and the at least one second outlet is switched to an off state.

3. The power management system of claim 2, wherein the first device is set to a low power state and the at least one second outlet is switched to an off state in the event an absence of a user is detected by the absence sensor.

4. The power management system of claim 2, wherein the at least one control outlet is a master outlet and the at least one second outlet is a slave outlet.

5. The power management system of claim 2, wherein the at least one first outlet is maintained at an on state.

6. The power management system of claim 2, wherein the power strip further comprises a masterless configuration such that the at least one second outlet is capable of individual switching.

7. The power management system of claim 6, wherein the individual switching is operated via an external device.

8. The power management system of claim 2, wherein the at least one interface is a high-level interface.

9. The power management system of claim 8, wherein the high-level interface is at least one of at least one wireless network, a high-definition multimedia interface, a universal serial bus interface, and any combination thereof.

10. The power management system of claim 2, wherein the absence sensor is selected from a group of proximity sensors.

11. The power management system of claim 2, wherein the absence sensor is selected from a group of optical sensors.

12. The power management system of claim 2, wherein the absence sensor is at least one of an infrared sensor, a passive infrared sensor, a motion sensor, a radio frequency sensor, and any combination thereof.

13. The power management system of claim 2, wherein the system is configured with a resettable timer function.

14. The power management system of claim 2, wherein the system is configured to determine power supply to the control device by sequentially sensing at least one activity of a user.

15. The power management system of claim 14, wherein the system terminates power supply when at least one activity is undetected within a predetermined period of time.

16. The power management system of claim 14, wherein the system:
a) detects a first activity for a first predetermined period of time;
b) detects a second activity for a subsequent predetermined period of time;
c) if the first activity is undetected within the first predetermined period of time, the system triggers an alert within a length of time; and
d) if the second activity is undetected at the end of the subsequent predetermined period of time, the system terminates power supply.

17. A power strip comprising:
at least one control outlet;
at least one first outlet operatively connected to the at least one control outlet;
at least one second outlet operatively connected to the at least one first outlet; and
at least one interface operatively connecting a control device connected to the at least one control outlet and a first device connected to the at least one first outlet,
wherein the power strip is configured to determine a status of the control device via the at least one interface and, if the status of the control device is determined to be in an off state, the first device is set to a low power state by sending a command to the first device via the at least one interface, and the at least one second outlet is switched to an off state.

18. The power strip of claim 17, wherein the at least one control outlet is a master outlet and the at least one second outlet is a slave outlet.

19. The power strip of claim 17, wherein the at least one first outlet is maintained at an on state.

20. The power strip of claim 17, wherein the power strip comprises a masterless configuration such that the at least one second outlet is capable of individual switching.

21. The power strip of claim 20, wherein the individual switching is operated via an external device.

22. The power strip of claim 17, wherein the at least one second outlet is switched to the off state by a mechanical relay.

23. The power strip of claim 17, wherein the at least one interface is a high-level interface.

24. The power strip of claim 23, wherein the high level interface is at least one of at least one wireless network, a high-definition multimedia interface, a universal serial bus interface, and any combination thereof.

25. The power strip of claim 17, wherein the power strip is configured with a resettable timer function.

26. The power strip of claim 17, wherein the power strip is configured with an absence sensor to detect presence of a user of the control device.
